(19) United States
(12) Patent Application Publication
(10) Pub. No.: US 2026/0219202 A1
(43) Pub. Date: Jul. 30, 2026

(54) PRODUCT INSPECTION SYSTEM CONTROL METHOD

(71) Applicant: LS ELECTRIC CO., LTD., Anyang-si, Gyeonggi-do (KR)

(72) Inventor: Sung Rok YOO, Anyang-si, Gyeonggi-do (KR)

(21) Appl. No.: 19/148,863

(22) PCT Filed: Jan. 15, 2024
(86) PCT No.: PCT/KR2024/000675

§ 371 Date: Jul. 17, 2025

(30) Foreign Application Priority Data
Feb. 14, 2023 (KR) 10-2023-0019120

(51) Int. Cl. G01N 21/88; G01N 21/93; G06N 3/08

(52) U.S. Cl. CPC G01N 21/8851; G01N 21/93; G06N 3/08; G01N 2021/8854; G01N 2021/8887

(57) ABSTRACT

A product inspection system control method is disclosed. The product inspection system control method according to one aspect of the present disclosure may comprise steps in which: (a) an image sensor unit generates a plurality of pieces of detection information about the exterior, in a plurality of directions, of a product; (b) a detection information storage unit stores the generated detection information; (c) an analysis information calculation unit calculates analysis information by using the stored detection information; and (d) an analysis information storage unit stores the calculated analysis information.

### CROSS-REFERENCE TO RELATED APPLICATIONS

This application is a National Stage of International Application No. PCT/KR2024/000675, filed Jan. 15, 2024, which claims priority to and the benefit of Korean Patent Application No. 10-2023-0019120, filed Feb. 14, 2023, the disclosures of which are incorporated herein by reference in its entirety.

### FIELD

The present disclosure relates to a method for controlling a product inspection system, and more specifically to a method for controlling a product inspection system that is capable of quickly and accurately inspecting the state of the exterior of a product.

### BACKGROUND

As the mass production and automation of products become more common, the method of manufacturing a plurality of products in succession rather than manufacturing a single product during the process has become more common. In this case, the process of manufacturing a plurality of products necessarily includes a quality inspection process that inspects the exterior of the manufactured products and the like.

The exterior inspection of a product is usually performed by examining the exterior of the product, that is, using information that can be recognized visually. The traditional form of exterior inspection was performed by having workers visually inspect each product and reflect the results in the process.

However, as technology has advanced, the speed at which workers can visually check the exterior of products one by one has become unable to keep up with the speed of product production. Accordingly, a method has been introduced in which data on the exterior of products is obtained using cameras and the like, and the data is used to inspect the exterior of products. However, since the above method also requires workers to review the generated data one by one, it is difficult to expect a significant speed increase.

Accordingly, recently, a method in which a device for external inspection directly determines the results of an external inspection of a product using artificial intelligence and the like is gaining attention. In the above case, data on the external exterior of a product is acquired, and a processor compares the acquired data with reference data to perform an inspection on the external exterior of the product.

However, products are usually formed in a three-dimensional shape. Accordingly, inspection of the product's exterior requires a procedure of acquiring and inspecting data on the exterior from a plurality of directions. Therefore, there is a concern that the process of acquiring data during the continuously performed product manufacturing process will become complicated. In addition, as the amount of acquired data increases, the computational process that the profit processor must perform also increases. As a result, there is a concern that the speed of the product's exterior inspection will decrease, thereby slowing down the overall speed of the manufacturing of the product.

Accordingly, technologies for efficiently performing inspections of product exterior have been introduced.

Korean Granted Patent Document No. 10-2475103 discloses an automobile quality management system. Specifically, it discloses an automobile quality management system that can obtain information about the exterior of an automobile from various directions using a plurality of camera units.

However, the automobile quality management system disclosed in the above related art document assumes that the automobile is maintained in a state of being supported by a lifter.

In other words, the above related art document does not provide a method for obtaining information for inspecting quality from various directions when an inspection object such as an automobile is moved.

Korean Granted Patent Document No. 10-2464530 discloses a PET bottle inspection device. Specifically, the PET bottle inspection device is disclosed in which the exterior of a PET bottle moving along a PET bottle conveyor is acquired as an image through a vision inspection unit, thereby allowing an inspector to inspect the exterior of the PET bottle.

However, the PET bottle inspection device disclosed in the above related art document requires an additional process in which the PET bottle is rotated about a vertical axis in the inspection section. In other words, the above related art document does not provide a method for obtaining information on the exterior of a PET bottle without affecting the manufacturing process of the PET bottle.
Korean Granted Patent Document No. 10-2475103 (Dec. 7, 2022
Korean Granted Patent Document No. 10-2464530 (Nov. 3, 2022

### SUMMARY

The present disclosure has been devised to solve the above problems, and an object of the present disclosure is to provide a method for controlling a product inspection system in which the inspection speed can be improved.

Another object of the present disclosure is to provide a method for controlling a product inspection system that is capable of obtaining necessary information without affecting the manufacturing process of the product.

Still another object of the present disclosure is to provide a method for controlling a product inspection system in which the accuracy of the inspection results can be improved.

Still another object of the present disclosure is to provide a method for controlling a product inspection system that is capable of verifying inspection results.

Still another object of the present disclosure is to provide a method for controlling a product inspection system that is capable of reflecting the inspection results in subsequent inspections.

The problems of the present disclosure are not limited to the problems mentioned above, and other problems that are not mentioned will be clearly understood by those skilled in the art to which the present disclosure pertains from the description below.

According to an aspect of the present disclosure, A method for controlling a product inspection system, the method including (a) generating, by an image sensor unit, a plurality of pieces of sensed information about an exterior of a product in a plurality of directions; (b) storing, by a sensed information storage unit, the generated sensed information; (c) calculating, by an analysis information calculation unit, analysis information by using the stored sensed information; and (d) storing, by an analysis information storage unit, the calculated analysis information.

In this case, the method for controlling a product inspection system may be provided, wherein step (a) includes (a1) generating, by a first sensor module, first sensed information about an exterior of the product in a first direction; (a2) generating, by a second sensor module, second sensed information about an exterior of the product in a second direction; and (a3) generating, by a third sensor module, third sensed information about an exterior of the product in a third direction.

In addition, the method for controlling a product inspection system may be provided, wherein step (a) includes (a4) generating, by a fourth sensor module, fourth sensed information about an exterior of the product in a fourth direction; (a5) generating, by a fifth sensor module, fifth sensed information about an exterior of the product in a fifth direction; and (a6) generating, by a sixth sensor module, sixth sensed information about an exterior of the product in a sixth direction.

In this case, the method for controlling a product inspection system may be provided, wherein step (b) includes (b1) storing, by a second sensed information storage module, a part of the plurality of pieces of sensed information generated by the image sensor unit; and (b2) storing, by a second sensed information storage module, a remainder of the plurality of pieces of sensed information generated by the image sensor unit.

In addition, the method for controlling a product inspection system may be provided, wherein step (c) includes (c1) calculating, by a first analysis information calculation unit, first analysis information using a part of the plurality of pieces of stored sensed information; and (c2) calculating, by a second analysis information calculation unit, second analysis information using a remainder of the plurality of pieces of stored sensed information.

In this case, the method for controlling a product inspection system may be provided, wherein step (c1) includes (c11) loading, by a sensed information load module, the part of the plurality of pieces of sensed information; (c12) calculating, by an analysis information calculation module, first analysis information by comparing the part of sensed information with pre-stored first learning information; (c13) classifying the first analysis information calculated by the analysis information calculation module into any one information of good product information and defective product information; and (c14) transferring the good product information and the defective product information classified by the analysis information calculation module to a first analysis information storage unit.

In addition, the method for controlling a product inspection system may be provided, wherein step (c2) includes (c21) loading, by a sensed information load module, the remainder of the plurality of pieces of sensed information; (c22) calculating, by an analysis information calculation module, second analysis information by comparing the part of the sensed information with pre-stored second learning information; (c23) classifying the second analysis information calculated by the analysis information calculation module into any one information of good product information and defective product information; and (c24) transferring the good product information and the defective product information classified by the analysis information calculation module to a second analysis information storage unit.

In this case, the method for controlling a product inspection system may be provided, wherein step (d) includes (d1) storing, by a first analysis information storage unit, first analysis information calculated by using a part of the plurality of pieces of sensed information; and (d2) storing, by a second analysis information storage unit, second analysis information calculated by using a remainder of the plurality of pieces of sensed information.

In addition, the method for controlling a product inspection system may be provided, wherein step (d1) includes (d11) storing, by a good product information storage module, good product information among the first analysis information; and (d12 storing, by a defective product information storage module, defective product information among the first analysis information.

In this case, the method for controlling a product inspection system may be provided, wherein step (d2) includes (d21) storing, by a good product information storage module, good product information among the second analysis information; and (d22 storing, by a defective product information storage module, defective product information among the second analysis information.

In this case, the method for controlling a product inspection system may be provided, wherein the method further includes (e) learning, by the analysis information calculation unit, pre-stored learning information.

In this case, the method for controlling a product inspection system may be provided, wherein step (e) includes (e1) learning, by a first analysis information calculation unit, first learning information about an exterior of a part of the product in a plurality of directions; and (e2) learning, by a second analysis information calculation unit, second learning information about an exterior of a remainder of the product in a plurality of directions.

In addition, the method for controlling a product inspection system may be provided, wherein step (e1) includes (e11) loading, by a learning information load module, good product learning information stored in a good product learning information storage module of a first learning information storage unit; (e12) loading, by a learning information load module, defective product learning information stored in a defective product learning information storage module of the first learning information storage unit; and (e13) learning the good product learning information and the defective product learning information loaded by a learning information learning module.

In this case, the method for controlling a product inspection system may be provided, wherein step (e2) includes (e21) loading, by a learning information load module, good product learning information stored in a good product learning information storage module of a second learning information storage unit; (e22) loading, by a learning information load module, defective product learning information stored in a defective product learning information storage module of the second learning information storage unit; and (e23) learning the good product learning information and the defective product learning information loaded by a learning information learning module.

In addition, the method for controlling a product inspection system may be provided, wherein the method further includes (f) correcting, by an analysis information correction unit, the stored analysis information.

In this case, the method for controlling a product inspection system may be provided, wherein step (f) includes (f1) correcting, by a first analysis information correction unit, first analysis information calculated by using the sensed information for an exterior of a part of the product in a plurality of directions; and (f2) correcting, by a second analysis information correction unit, second analysis information calculated by using the sensed information for an exterior of a remainder of the product in a plurality of directions.

In addition, the method for controlling a product inspection system may be provided, wherein step (f1) includes (f11) receiving, by a correction information input module, an input of first correction information for correcting the first analysis information; and (f12) modifying, by an analysis information modification module, the first analysis information according to the first modification information.

In this case, the method for controlling a product inspection system may be provided, wherein step (f2) includes (f21) receiving, by a correction information input module, an input of second correction information for correcting the second analysis information; and (f22) modifying, by an analysis information modification module, the second analysis information according to the second correction information.

In addition, the method for controlling a product inspection system may be provided, wherein the method further includes (g) updating, by a learning information storage unit, the learning information by using the corrected analysis information.

In this case, the method for controlling a product inspection system may be provided, wherein step (g) includes (g1) updating, by a first learning information storage unit, first learning information by receiving first analysis information calculated by using the sensed information about an exterior of a part of the product in a plurality of directions, and corrected by a first analysis information correction unit; and (g2) updating, by a second learning information storage unit, second learning information by receiving second analysis information calculated by using the sensed information about an exterior of a remainder of the product in a plurality of directions, and corrected by a second analysis information correction unit.

In addition, the method for controlling a product inspection system may be provided, wherein step (g1) includes (g11) adding, by a good product learning information storage module, good product information among the transferred first analysis information to good product learning information; and (g12) adding, by a defective product learning information storage module, defective product learning information among the transferred first analysis information to defective product learning information.

In this case, the method for controlling a product inspection system may be provided, wherein step (g2) includes (g21) adding, by a good product learning storage module, good product information among the transferred second analysis information to good product learning information; and (g22) adding, by a defective product learning information storage module, defective product information among the transferred second analysis information to defective product learning information.

According to the above configuration, the method for controlling a product inspection system according to an embodiment of the present disclosure can improve the inspection speed.

The image sensor unit generates a plurality of pieces of sensed information about the exterior of a product. The plurality of pieces of sensed information are transferred to and stored in the sensed information storage unit. In this case, the sensed information storage unit includes a first sensed information storage module that stores a part of the plurality of pieces of sensed information and a second sensed information storage module that stores a remainder. That is, the generated plurality of pieces of sensed information are separately stored in a plurality of sensed information storage modules.

In addition, the analysis information calculation unit is composed of a plurality of units, and is electrically connected to the first sensed information storage module and the second sensed information storage module, respectively. That is, the first analysis information calculation unit calculates analysis information using the part of the sensed information stored in the first sensed information storage module. In addition, the second analysis information calculation unit calculates analysis information using the remainder of the sensed information stored in the second sensed information storage module.

Therefore, the generated sensed information can be calculated into analysis information in parallel by a plurality of analysis information calculation units. In other words, a plurality of analysis information calculation units can calculate analysis information using different sensed information.

Therefore, the calculation speed can be improved compared to when a single analysis information calculation unit calculates the analysis information. Accordingly, not only the inspection speed of the product's exterior but also the speed of the entire product manufacturing process can be improved.

In addition, according to the above configuration, the method for controlling a product inspection system according to an embodiment of the present disclosure can obtain necessary information without affecting the manufacturing process of a product.

A plurality of image sensor units are provided. The plurality of image sensor units are positioned adjacent to a manufacturing line that transports the product, and can generate sensed information on the exterior of a product in a plurality of directions.

In this case, the image sensor unit is positioned adjacent to the manufacturing line but separated from the manufacturing line so as not to affect the movement of a product.

Accordingly, the image sensor unit can generate sensed information on the product's exterior in a plurality of directions without affecting the product's manufacturing process. Accordingly, sensed information required for product exterior inspection can be smoothly generated while the product's manufacturing process proceeds smoothly.

In addition, according to the above configuration, the method for controlling a product inspection system according to an embodiment of the present disclosure can improve the accuracy of inspection results.

The product inspection system is provided with a learning information storage unit. The learning information storage unit stores learning information, which is analysis information corrected by an operator or an external control module among the calculated analysis information. In other words, learning information can be defined as accurately calculated analysis information.

The learning information storage unit is electrically connected to the analysis information calculation unit. The learning information stored in the learning information storage unit is provided to the analysis information calculation unit and used as basis data for calculating the sensed information into analysis information. In other words, the analysis information calculation unit can calculate analysis information based on the accumulated stored learning information.

Therefore, as the test results accumulate, the accuracy of the analysis information calculated by the analysis information calculation unit can be improved.

In addition, according to the above configuration, the method for controlling a product inspection system according to an embodiment of the present disclosure can verify inspection results.

The product inspection system is provided with an analysis information correction unit. The analysis information correction unit receives correction information from an operator or an external control module. The analysis information correction unit modifies the analysis information stored in the analysis information storage unit based on the input correction information.

Therefore, the analysis information calculated by the analysis information calculation unit is first calculated based on learning information, and then goes through a correction process again by the analysis information correction unit. Accordingly, the calculated analysis information can be verified, and the reliability of the analysis information inspection results can be improved.

In addition, according to the above configuration, the method for controlling a product inspection system according to an embodiment of the present disclosure can reflect the inspection results in a subsequent inspection.

As described above, the calculated analysis information is stored in the analysis information storage unit. The stored analysis information undergoes a correction process by the analysis information correction unit and then stored in the learning information storage unit. The learning information stored in the learning information storage unit is fed back to the analysis information calculation unit, and is used as the basis for the analysis information calculation unit to calculate the analysis information.

Therefore, the inspection results of the product's exterior and the corrections thereto can be fed back and used as a basis for calculating analysis information again. Accordingly, the inspection results of the product's exterior can be reflected in subsequent inspections.

It should be understood that the effects of the present disclosure are not limited to the effects described above, but include all effects that can be inferred from the constitutions of the disclosure described in the detailed description or claims of the present disclosure.

### BRIEF DESCRIPTION OF THE DRAWINGS

FIG. 1 is a block diagram illustrating the configuration of a product inspection system according to an embodiment of the present disclosure.

FIG. 2 is a usage diagram exemplifying the arrangement method of an image sensor unit provided in the product inspection system of FIG. 1.

FIG. 3 is a block diagram illustrating the configurations of an image sensor unit and a sensed information storage unit provided in the product inspection system of FIG. 1 and the relationship between the movement of information.

FIG. 4 is a block diagram illustrating the information movement relationship between a sensed information storage unit and an analysis information calculation unit provided in the product inspection system of FIG. 1.

FIG. 5 is a block diagram illustrating the configuration of an analysis information calculation unit provided in the inspection product system of FIG. 1.

FIG. 6 is a block diagram illustrating an analysis information storage unit provided in the product inspection system of FIG. 1 and the relationship of information movement in the analysis information storage unit.

FIG. 7 is a block diagram illustrating the relationship of the information movement between an analysis information storage unit and a learning information storage unit provided in the product inspection system of FIG. 1.

FIG. 8 is a block diagram illustrating the configuration of a learning information storage unit provided in the product inspection system of FIG. 1.

FIG. 9 is a block diagram illustrating the configuration of a learning information storage unit provided in the product inspection system of FIG. 1.

FIG. 10 is a block diagram illustrating the relationship of the information movement between an analysis information storage unit and an analysis information correction unit provided in the product inspection system of FIG. 1.

FIG. 11 is a block diagram illustrating the configuration of an analysis information correction unit provided in the product inspection system of FIG. 1.

FIG. 12 is a block diagram showing the relationship of the information movement between an analysis information storage unit and an analysis information correction unit provided in the product inspection system of FIG. 1.

FIG. 13 is a flowchart illustrating the flow of a method for controlling a product inspection system according to an embodiment of the present disclosure.

FIG. 14 is a flowchart illustrating the detailed flow of step S100 of the method for controlling a product inspection system of FIG. 13.

FIG. 15 is a flowchart illustrating the detailed flow of step S200 of the method for controlling a product inspection system of FIG. 13.

FIG. 16 is a flowchart illustrating the detailed flow of step S300 of the method for controlling a product inspection system of FIG. 13.

FIG. 17 is a flowchart illustrating the detailed flow of step S310 of the method for controlling a product inspection system of FIG. 16.

FIG. 18 is a flowchart illustrating the detailed flow of step S320 of the method for controlling a product inspection system of FIG. 16.

FIG. 19 is a flowchart illustrating the detailed flow of step S400 of the method for controlling a product inspection system of FIG. 13.

FIG. 20 is a flowchart illustrating the detailed flow of steps S410 and S420 of the method for controlling a product inspection system of FIG. 19.

FIG. 21 is a flowchart illustrating the detailed flow of step S500 of the method for controlling a product inspection system of FIG. 13.

FIG. 22 is a flowchart illustrating the detailed flow of step S510 of the method for controlling a product inspection system of FIG. 21.

FIG. 23 is a flowchart illustrating the detailed flow of step S520 of the method for controlling a product inspection system of FIG. 21.

FIG. 24 is a flowchart illustrating the detailed flow of step S600 of the method for controlling a product inspection system of FIG. 13.

FIG. 25 is a flowchart illustrating the detailed flow of steps S610 and S620 of the method for controlling a product inspection system of FIG. 24.

FIG. 26 is a flowchart illustrating the detailed flow of step S700 of the method for controlling a product inspection system of FIG. 13.

FIG. 27 is a flowchart illustrating the detailed flow of steps S710 and S720 of the method for controlling a product inspection system of FIG. 26.

### DETAILED DESCRIPTION

Hereinafter, with reference to the attached drawings, embodiments of the present disclosure will be described in detail so that those with ordinary skill in the art can easily practice the present disclosure. The present disclosure may be implemented in various different forms and is not limited to the embodiments described herein. In order to clearly describe the present disclosure, parts that are not related to the description are omitted in the drawings, and the same reference numerals are assigned to the same or similar components throughout the specification.

The words and terms used in the present specification and claims should not be construed as limited to their usual or dictionary meanings, but should be interpreted as having meanings and concepts consistent with the technical idea of the present disclosure, in accordance with the principles by which the inventor can define terms and concepts in order to best describe his or her disclosure.

Therefore, the embodiments described in the present specification and the configurations illustrated in the drawings correspond to preferred embodiments of the present disclosure and do not represent all of the technical ideas of the present disclosure, and thus, the corresponding configurations may have various equivalents and modified examples that can replace the same at the time of filing of the present disclosure.

In the following description, descriptions of some components may be omitted to clarify the features of the present disclosure.

### 1. Definition of Terms

The term “electrical conduction” used in the following description means that one or more members are connected to each other such that they can transmit current or electrical signals. In one embodiment, the electrical conduction may be formed in a wired form such as by a conductor member, or in a wireless form such as Bluetooth, Wi-Fi, RFID and the like. In one embodiment, the electrical conduction may include the meaning of “communication.”

### 2. Description of the Configuration of a Product Inspection System 10 According to an Embodiment of the Present Disclosure

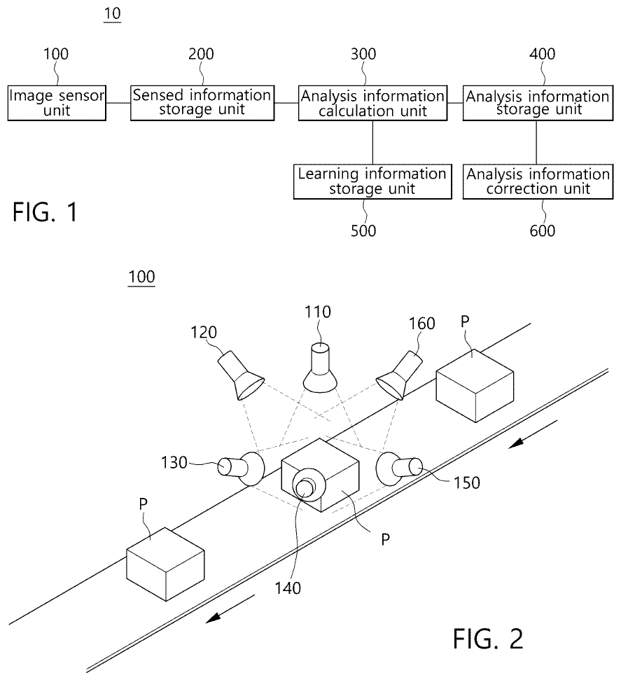

Referring to FIG. 1, the configuration of a product inspection system 10 according to an embodiment of the present disclosure is illustrated. The product inspection system 10 according to an embodiment of the present disclosure generates information on an exterior of a product P manufactured and moved along a manufacturing line L, and may perform an inspection on the exterior of the product P using the information.

In this case, the product inspection system 10 may generate information on the exterior of the product P along a plurality of directions, and calculate the inspection results on the exterior of the product through a plurality of calculation processes on a plurality of pieces of information. That is, the product inspection system 10 according to an embodiment of the present disclosure may perform the exterior inspection of the product in the form of a dual or multi module.

Accordingly, the process of acquiring the information and the process of calculating the inspection results for the exterior of the product using the acquired information may be performed quickly.

In addition, the results of the performed inspection may be reviewed by an operator or compared with data on the exterior of a preset product, and used for learning by the product inspection system 10 to calculate accurate inspection results. That is, the product inspection system 10 according to an embodiment of the present disclosure is implemented to enable machine learning or deep learning such that it can update and evolve data for the exterior inspection of a product on its own.

Therefore, the reliability of the calculated inspection results is enhanced, and the process of calculating the inspection results for the product's exterior may also be performed quickly.

In the embodiment illustrated in FIG. 1, the product inspection system 10 includes an image sensor unit 100, a sensed information storage unit 200, an analysis information calculation unit 300, an analysis information storage unit 400, a learning information storage unit 500 and an analysis information correction unit 600.

The image sensor unit 100 generates sensed information SI about the exterior of a product P. The image sensor unit 100 is positioned adjacent to a manufacturing line L on which the product P is installed and moved. The image sensor unit 100 is electrically connected to the sensed information storage unit 200 such that the generated sensed information SI can be transferred to the sensed information storage unit 200.

The image sensor unit 100 may be provided in any form that is capable of generating sensed information SI about the exterior of the product P. In one embodiment, the image sensor unit 100 may be provided in the form of a camera.

A plurality of image sensor units 100 may be provided. The plurality of image sensor units 100 may each generate sensed information SI about the exterior of the product P from different directions. The generated plurality of pieces of sensed information SI may each be transferred to the sensed information storage unit 200.

In the embodiment illustrated in FIG. 2, the image sensor unit 100 includes a first sensor module 110, a second sensor module 120, a third sensor module 130, a fourth sensor module 140, a fifth sensor module 150 and a sixth sensor module 160.

The first sensor module 110 generates first sensed information SI1 about the exterior of the product P in a first direction. In the illustrated embodiment, the first sensor module 110 generates first sensed information SI1 about an upper side of the product P.

The second sensor module 120 generates second sensed information SI3 about the exterior of the product P in a second direction. In the illustrated embodiment, the second sensor module 120 generates second sensed information SI3 about a left side of the product P.

The third sensor module 130 generates third sensed information SI3 about the exterior of the product P in a third direction. In the illustrated embodiment, the third sensor module 130 generates third sensed information SI3 about a front side of the product P.

The fourth sensor module 140 generates fourth sensed information SI4 about the exterior of the product P in a fourth direction. In the illustrated embodiment, the fourth sensor module 140 generates fourth sensed information SI4 about a viewing direction of the product P.

The fifth sensor module 150 generates fifth sensed information SI5 about the exterior of the product P in the fifth direction. In the illustrated embodiment, the fifth sensor module 150 generates fifth sensed information SI5 about a right direction of the product P.

The sixth sensor module 160 generates sixth sensed information SI6 about the exterior of the product P in a sixth direction. In the illustrated embodiment, the sixth sensor module 160 generates sixth sensed information SI6 about a rear side of the product P.

That is, the first to sixth sensor modules 110, 120, 130, 140, 150, 160 may each generate sensed information SI1, SI2, SI3, SI4, SI5, SI6 about the exterior of the product P from different directions. The generated first to sixth sensed information SI1, SI2, SI3, SI4, SI5, SI6 are each transferred to the sensed information storage unit 200.

In this case, a part of the plurality of pieces of sensed information SI generated by the first to sixth sensor modules 110, 120, 130, 140, 150, 160 may be transferred to a first sensed information storage module 210, and a remainder may be transferred to a second sensed information storage module 220.

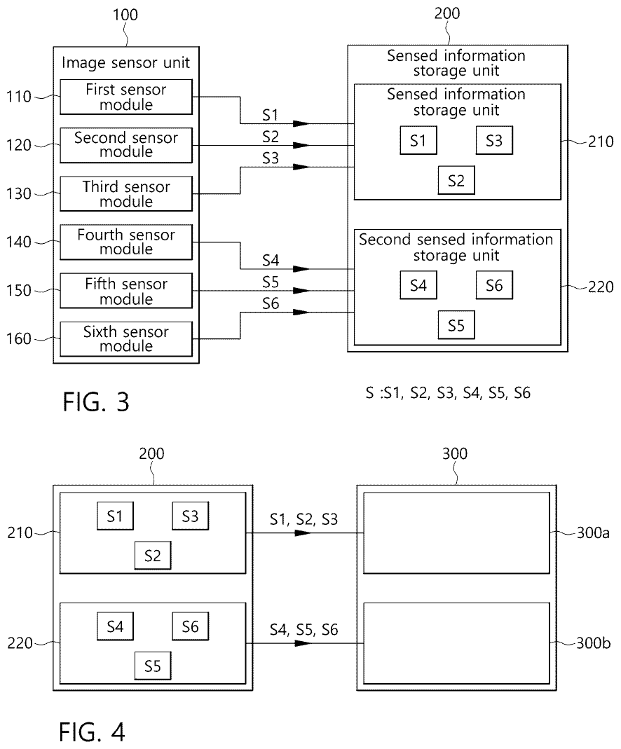

In the embodiment illustrated in FIG. 3, the first to third sensed information SI1, SI2, SI3 generated by the first to third sensor modules 110, 120, 130 respectively are transferred to the first sensed information storage module 210. In addition, the fourth to sixth sensed information SI4, SI5, SI6 generated by the fourth to sixth sensor modules 140, 150, 160 respectively are transferred to the second sensed information storage module 220.

The first to third sensed information SI1, SI2, SI3 and the fourth to sixth sensed information SI4, SI5, SI6 transferred to each sensed information storage module 210, 220 are transferred to different analysis information calculation units 300a, 300b and utilized to calculate analysis information AI1, AI2, respectively.

The sensed information storage unit 200 receives and stores sensed information SI generated by the image sensor unit 100. The sensed information storage unit 200 is electrically connected to the image sensor unit 100.

In addition, the sensed information storage unit 200 may provide stored sensed information SI to the analysis information calculation unit 300. The sensed information storage unit 200 is electrically connected to the analysis information calculation unit 300.

The sensed information storage unit 200 may be provided in any form that allows input, storage and output of information. In one embodiment, the sensed information storage unit 200 may be provided as an electrical device including a RAM, a ROM, an HDD, an SSD, an SD Disk and the like.

As described above, the sensed information SI may be generated in a plurality of pieces by a plurality of sensor modules 110, 120, 130, 140, 150. The sensed information storage unit 200 may store the received plurality of sensed information SI1, SI2, SI3, SI4, SI5, SI6 by distinguishing the same. To this end, the sensed information storage unit 200 may include a plurality of configurations that are electrically connected to a part and a remainder of the plurality of sensor modules 110, 120, 130, 140, 150, 160, respectively.

In the embodiment illustrated in FIG. 3, the sensed information storage unit 200 includes a first sensed information storage module 210 and a second sensed information storage module 220.

The first sensed information storage module 210 is electrically connected to the first to third sensor modules 110, 120, 130, respectively. The first sensed information storage module 210 receives and stores the first to third sensed information SI1, SI2, SI3.

The second sensed information storage module 220 is electrically connected to the fourth to sixth sensor modules 140, 150, 160, respectively. The second sensed information storage module 220 receives and stores the fourth to sixth sensed information SI4, SI5, SI6.

In the embodiment illustrated in FIG. 4, the first to third sensed information SI1, SI2, SI3 stored in the first sensed information storage module 210 may be transferred to the first analysis information calculation unit 300a. The first sensed information storage module 210 is electrically connected to the first analysis information calculation unit 300a.

In addition, the fourth to sixth sensed information SI4, SI5, SI6 stored in the second sensed information storage module 220 may be transferred to the second analysis information storage unit 300b. The second sensed information storage module 220 is electrically connected to the second analysis information calculation unit 300b.

The analysis information calculation unit 300 calculates analysis information AI on the inspection results of the exterior of the product P using the generated sensed information SI. The analysis information calculation unit 300 is electrically connected to the sensed information storage unit 200.

In addition, the analysis information AI calculated by the analysis information calculation unit 300 is transferred to and stored in the analysis information storage unit 400. The analysis information calculation unit 300 is electrically connected to the analysis information storage unit 400.

Furthermore, the analysis information calculation unit 300 may receive learning information LI from the learning information storage unit 500 and perform learning to operate analysis information AI.

The analysis information calculation unit 300 is electrically connected to the learning information storage unit 500.

The analysis information calculation unit 300 may be provided in any form that is capable of inputting calculating, and outputting information. In one embodiment, the analysis information calculation unit 300 may be provided as an electrical device including a CPU or a microprocessor.

As described above, the sensed information storage unit 200 includes a first sensed information storage module 210 that is electrically connected to the first to third sensor modules 110, 120, 130 to receive and store the first to third sensed information SI1, SI2, SI3, and a second sensed information storage module 220 that is electrically connected to the fourth to sixth sensor modules 140, 150, 160 to receive and store the fourth to sixth sensed information SI4, SI5, SI6.

Accordingly, the analysis information calculation unit 300 may also include a configuration in which the first sensed information storage module 210 is electrically connected to receive first to third sensed information SI1, SI2, SI3 and another configuration in which the second sensed information storage module 220 is electrically connected to receive fourth to sixth sensed information SI4, SI5, SI6.

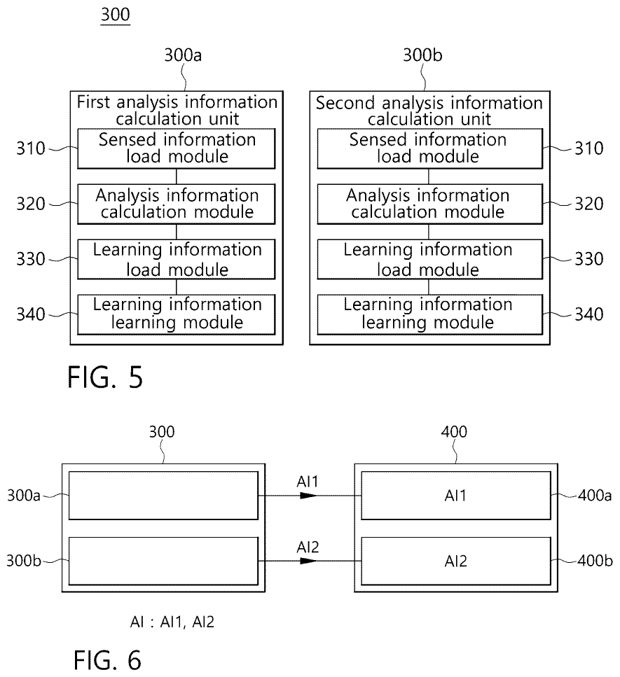

In the embodiment illustrated in FIG. 5, the analysis information calculation unit 300 includes a first analysis information calculation unit 300a and a second analysis information calculation unit 300b.

The first analysis information calculation unit 300a is electrically connected to the first sensed information storage module 210 and receives first to third sensed information SI1, SI2, SI3. The first analysis information calculation unit 300a calculates first analysis information AI1 on the exterior in the first to third directions using the first to third sensed information SI1, SI2, SI3.

In addition, the first analysis information calculation unit 300a is electrically connected to the first analysis information storage unit 400a to transfer the calculated first analysis information AI1 to the first analysis information storage unit 400a.

Furthermore, the first analysis information calculation unit 300a is electrically connected to a first learning information storage unit 500a to receive the first learning information LI1. The first analysis information calculation unit 300a may perform learning to calculate the first analysis information AI1 using the transferred first learning information LI1.

The second analysis information calculation unit 300b is electrically connected to the second sensed information storage module 220 and receives the fourth to sixth sensed information SI4, SI5, SI6. The second analysis information calculation unit 300b calculates the second analysis information AI2 on the exterior in the fourth to sixth directions using the fourth to sixth sensed information SI4, SI5, SI6.

In addition, the second analysis information calculation unit 300b is electrically connected to the second analysis information storage unit 400b to transfer the calculated second analysis information AI2 to the second analysis information storage unit 400b.

Furthermore, the second analysis information calculation unit 300b is electrically connected to a second learning information storage unit 500b to receive the second learning information LI2. The second analysis information calculation unit 300b may perform learning to calculate the second analysis information AI2 using the received second learning information LI2.

In the embodiment illustrated in FIG. 5, the first analysis information calculation unit 300a and the second analysis information calculation unit 300b each include a sensed information load module 310, an analysis information calculation module 320, a learning information load module 330 and a learning information learning module 340.

The sensed information load module 310 is electrically connected to the sensed information storage unit 200 and receives stored sensed information SI.

In this case, the sensed information load module 310 provided in the first analysis information calculation unit 300a is electrically connected to the first sensed information storage module 210 to receive the first to third sensed information SI1, SI2, SI3.

In addition, the sensed information load module 310 provided in the second analysis information calculation unit 300b is electrically connected to the second sensed information storage module 220 to receive the fourth to sixth sensed information SI4, SI5, SI6.

The sensed information SI received by the sensed information load module 310 is transferred to the analysis information calculation module 320. The sensed information load module 310 is electrically connected to the analysis information calculation module 320.

The analysis information calculation module 320 calculates analysis information AI using the received sensed information SI. The analysis information calculation module 320 may calculate analysis information AI by comparing the learning information LI stored in the learning information storage unit 500 with the received sensed information SI.

In this case, the analysis information calculation module 320 may calculate the analysis information AI as any one of good product information or defective product information. Good product information may be defined as information indicating that the exterior of the product P is normal, that is, the product P is good. In addition, defective product information may be defined as information indicating that the exterior of the product P is abnormal, that is, the product P is defective.

In this case, the analysis information calculation module 320 provided in the first analysis information calculation unit 300a calculates the first analysis information AI1 using the first to third sensed information SI1, SI2, SI3. The calculated first analysis information AI1 may be understood as information on the inspection result of the exterior of the product P in the first to third directions.

As illustrated in FIG. 6, the first analysis information AI1 calculated by the analysis information calculation module 320 provided in the first analysis information calculation unit 300a is transferred to the first analysis information storage unit 400a. The first analysis information calculation unit 300a is electrically connected to the first analysis information storage unit 400a.

In addition, the analysis information calculation module 320 provided in the second analysis information calculation unit 300b calculates the second analysis information AI2 using the fourth to sixth sensed information SI4, SI5, SI6. The calculated second analysis information AI2 may be understood as information on the inspection results of the exterior of the product P in the fourth to sixth directions.

As illustrated in FIG. 6, the second analysis information AI2 calculated by the analysis information calculation module 320 provided in the second analysis information calculation unit 300b is transferred to the second analysis information storage unit 400b. The second analysis information calculation unit 300b is electrically connected to the second analysis information storage unit 400b.

The learning information load module 330 is electrically connected to the learning information storage unit 500 and receives learning information LI.

The learning information LI received by the learning information load module 330 is transferred to the analysis information calculation module 320 and may be utilized as reference data for calculating analysis information AI. The learning information load module 330 is electrically connected to the analysis information calculation module 320.

In this case, the learning information LI may include good product information, which is learning information LI indicating that the product P is good, and defective product information, which is learning information LI indicating that the product P is defective. Accordingly, the learning information load module 330 may receive all of good product information and defective product information. In other words, it will be understood that the learning information LI is a concept that includes all of good product information and defective product information.

In addition, the learning information LI received by the learning information load module 330 is transferred to the learning information learning module 340 and may be utilized as learning data to improve the accuracy of the calculation result of the analysis information AI. The learning information load module 330 is electrically connected to the learning information learning module 340.

As illustrated in FIG. 8, the learning information load module 330 provided in the first analysis information calculation unit 300a is electrically connected to the first learning information storage unit 500a and may receive the first learning information LI1.

In addition, the analysis information calculation module 320, the learning information load module 330 and the learning information learning module 340 provided in the first analysis information calculation unit 300a are electrically connected to each other such that the received first learning information LI1 may be shared.

Likewise, as illustrated in FIG. 8, the learning information load module 330 provided in the second analysis information calculation unit 300b is electrically connected to the second learning information storage unit 500b and may receive second learning information LI2.

In addition, the analysis information calculation module 320, the learning information load module 330 and the learning information learning module 340 provided in the second analysis information calculation unit 300b are electrically connected to each other such that the received second learning information LI2 may be shared.

The learning information learning module 340 learns learning information LI transferred from the learning information storage unit 500. The results learned by the learning information learning module 340 are transferred to the analysis information calculation module 320 and utilized to improve the accuracy of the operation results of the analysis information calculation module 320. The learning information learning module 340 is electrically connected to the analysis information calculation module 320.

The learning information learning module 340 is electrically connected to the learning information load module 330 and may receive learning information LI. In this case, the learning information learning module 340 may receive all of good product information and defective product information and learn the same.

The analysis information storage unit 400 receives and stores the analysis information AI calculated by the analysis information calculation unit 300. The analysis information storage unit 400 is electrically connected to the analysis information calculation module 320 of the analysis information calculation unit 300.

Analysis information AI stored in the analysis information storage unit 400 may be corrected by the analysis information correction unit 600. The analysis information storage unit 400 is electrically connected to the analysis information correction unit 600.

In addition, the analysis information AI stored in the analysis information storage unit 400 may be converted into learning information LI through the above correction and transferred to the learning information storage unit 500. The analysis information storage unit 400 is electrically connected to the learning information storage unit 500.

The analysis information storage unit 400 may be provided in any form that allows input, storage and output of information. In one embodiment, the analysis information storage unit 400 may be provided as an electrical device including a RAM, a ROM, an HDD, an SSD, an SD Disk and the like.

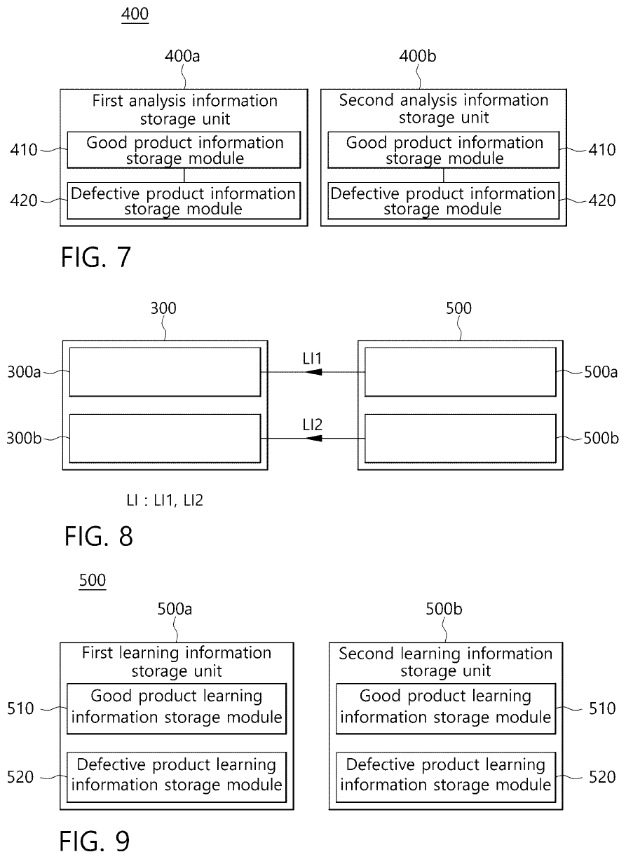

In FIG. 7, the analysis information storage unit 400 includes a second analysis information storage unit 400b that is electrically connected to the first analysis information storage unit 400a and the second analysis information calculation unit 300b to receive and store second analysis information AI2.

The first analysis information storage unit 400a is electrically connected to the first analysis information calculation unit 300a to receive and store the first analysis information AI1. The first analysis information storage unit 400a is electrically connected to the first analysis information correction unit 600a to receive the first correction information CI1.

In addition, the first analysis information storage unit 400a is electrically connected to the first learning information storage unit 500a and may transfer the first analysis information AI1 corrected according to the first correction information CI1. The corrected first analysis information AI1 may be utilized to update the first learning information LI1.

The second analysis information storage unit 400b is electrically connected to the second analysis information calculation unit 300b to receive and store second analysis information AI2. The second analysis information storage unit 400b is electrically connected to the second analysis information correction unit 600b to receive second correction information CI2.

In addition, the second analysis information storage unit 400b is electrically connected to the second learning information storage unit 500b and may transfer the second analysis information AI2 corrected according to the second correction information CI2. The corrected second analysis information AI2 may be utilized to update the second learning information LI2.

As described above, the calculated analysis information AI includes good product information and defective product information. Accordingly, the analysis information storage unit 400 includes a good product information storage module 410 and a defective product information storage module 420.

The good product information storage module 410 is electrically connected to the analysis information calculation module 320 and receives the calculated analysis information AI. The good product information storage module 410 stores good product information among the transferred analysis information AI.

The good product information storage module 410 is electrically connected to the analysis information correction unit 600. The good product information stored in the good product information storage module 410 may be corrected by correction information CI.

The good product information storage module 410 is electrically connected to a good product learning information storage module 510. The corrected good product information may be transferred to the good product learning information storage module 510.

The defective product information storage module 420 is electrically connected to the analysis information calculation module 320 and receives the calculated analysis information AI. The defective product information storage module 420 stores defective product information among the transferred analysis information AI.

The defective product information storage module 420 is electrically connected to the analysis information correction unit 600. The defective product information stored in the defective product information storage module 420 may be corrected by correction information CI.

The defective product information storage module 420 is electrically connected to the defective product learning information storage module 520. The corrected defective product information may be transferred to the defective product learning information storage module 520.

The learning information storage unit 500 stores learning information LI for improving the calculation results of the analysis information AI of the analysis information calculation unit 300. The learning information storage unit 500 is electrically connected to the learning information load module 330 of the analysis information calculation unit 300 (see FIG. 8).

The learning information storage unit 500 may receive the analysis information AI corrected by the pre-calculated analysis information AI or the correction information CI and update the stored learning information LI. The learning information storage unit 500 is electrically connected to the analysis information storage unit 400.

The learning information storage unit 500 may be provided in any form that allows input, storage and output of information. In one embodiment, the learning information storage unit 500 may be provided as an electrical device including a RAM, a ROM, an HDD, an SSD, an SD Disk and the like.

The learning information storage unit 500 may include one configuration that is electrically connected to the first analysis information calculation unit 300a and the first analysis information storage unit 400a and another configuration that is electrically connected to the second analysis information calculation unit 300b and the second analysis information storage unit 400b.

In the embodiment illustrated in FIG. 9, the learning information storage unit 500 includes a first learning information storage unit 500a and a second learning information storage unit 500b.

The first learning information storage unit 500a is electrically connected to the first analysis information calculation unit 300a and the first analysis information storage unit 400a. The first learning information storage unit 500a may receive the first analysis information AI1 and transfer the first learning information LI1.

The second learning information storage unit 500b is electrically connected to the second analysis information calculation unit 300b and the second analysis information storage unit 400b. The second learning information storage unit 500b may receive the second analysis information AI2 and transfer the second learning information LI2.

As described above, the analysis information AI may be calculated as any one of good product information or defective product information. Accordingly, the learning information LI for improving the standard of the analysis information AI and the calculation result of the calculated analysis information AI may also include good product learning information and defective product information.

Accordingly, the learning information storage unit 500 includes a good product learning information storage module 510 and a defective product learning information storage module 520.

The good product learning information storage module 510 stores good product learning information among learning information LI. The good product learning information storage module 510 is electrically connected to the learning information load module 330 and the good product information storage module 410.

The defective product learning information storage module 520 stores defective product learning information among learning information LI. The defective product learning information storage module 520 is electrically connected to the learning information load module 330 and the defective product information storage module 420.

The analysis information correction unit 600 receives correction information CI for correcting the analysis information AI stored in the analysis information storage unit 400. The correction information CI may be understood as information for correcting the analysis information AI such that the calculated analysis information AI matches the state of an actual product P.

The analysis information correction unit 600 may correct the analysis information AI stored in the analysis information storage unit 400 using authorized correction information CI. The analysis information correction unit 600 is electrically connected to the analysis information storage unit 400.

The analysis information correction unit 600 may be provided in any form that allows input, calculation and output of information. In one embodiment, the analysis information correction unit 600 may be provided in the form of an electronic device including a CPU or microprocessor.

The analysis information correction unit 600 may include one configuration that is electrically connected to the first analysis information storage unit 400a and another configuration that is electrically connected to the second analysis information storage unit 400b.

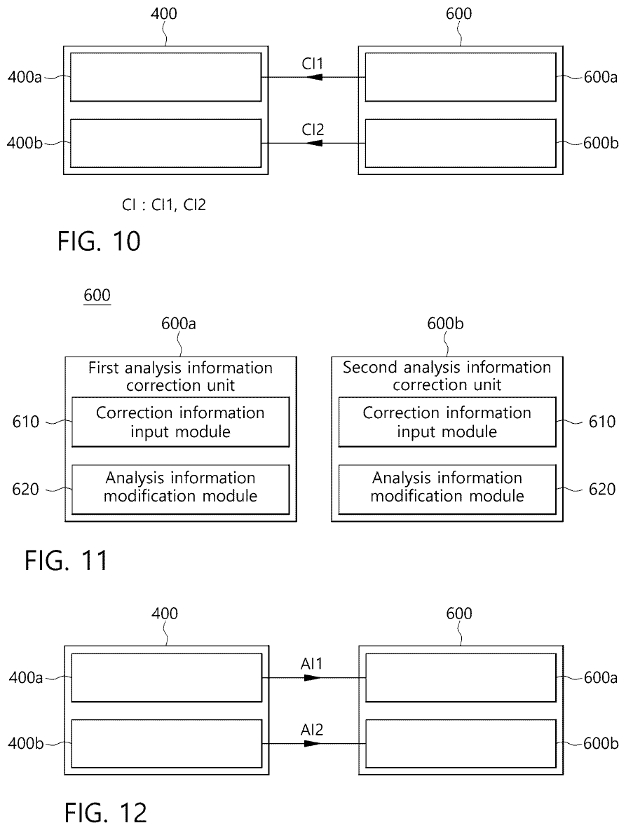

In the embodiments illustrated in FIGS. 10 to 12, the analysis information correction unit 600 includes a first analysis information correction unit 600a and a second analysis information correction unit 600b.

The first analysis information correction unit 600a is electrically connected to the first analysis information storage unit 400a. The first analysis information correction unit 600a may correct the first analysis information AI1 according to the first correction information CI1.

In this case, the first analysis information correction unit 600a may directly correct the first analysis information AI1 stored in the first analysis information storage unit 400a according to the first correction information CI1. In another embodiment, the first analysis information correction unit 600a may receive the first analysis information AI1, correct the same, and then transfer the same back to the first analysis information storage unit 400a. In the above embodiment, the first correction information CI1 may be utilized to indicate the corrected first analysis information AI1.

The second analysis information correction unit 600b is electrically connected to the second analysis information storage unit 400b. The second analysis information correction unit 600b may correct the second analysis information AI2 according to the second correction information CI2.

In this case, the second analysis information correction unit 600b may directly correct the second analysis information AI2 stored in the second analysis information storage unit 400b according to the second correction information CI2. In another embodiment, the second analysis information correction unit 600b may receive the second analysis information AI2, correct the same, and then transfer the same back to the second analysis information storage unit 400b. In the above embodiment, the second correction information CI2 may be utilized to indicate the corrected second analysis information AI2.

In the illustrated embodiment, the analysis information correction unit 600 includes a correction information input module 610 and an analysis information modification module 620.

The correction information input module 610 is electrically connected to an external input module (not shown) and receives correction information CI. In one embodiment, the external input module (not shown) may be provided with a touch screen, panel or button for receiving correction information CI from an operator or the like.

The correction information CI received by the correction information input module 610 is transferred to the analysis information modification module 620. The correction information input module 610 is electrically connected to the analysis information modification module 620.

The analysis information modification module 620 modifies the analysis information AI according to the input correction information CI. The analysis information modification module 620 is electrically connected to the analysis information storage unit 400.

As described above, the analysis information modification module 620 may directly modify the good product information or the defective product information stored in the analysis information storage unit 400. In another embodiment, the analysis information modification module 620 may receive analysis information AI, modify the same, and then transfer the same back to the analysis information storage unit 400.

The product inspection system 10 according to an embodiment of the present disclosure described above performs the generation of sensed information SI, calculation of analysis information AI, learning of learning information LI and correction using correction information CI in a dual channel manner.

Therefore, the amount of information that each dual channel must compute and store may be reduced compared to when a single channel computes and stores all information. As a result, the inspection process for the exterior of a product P may be performed quickly.

In addition, the analysis information calculation unit 300 may perform learning to improve the accuracy of the inspection results for the exterior of the product P by using the learning information LI stored in the learning information storage unit 500. Accordingly, the accuracy of the calculated analysis information AI may be improved.

Furthermore, the analysis information correction unit 600 may correct the stored analysis information AI, that is, the analysis information AI calculated by the analysis information calculation unit 300, using the input correction information CI. Therefore, the accuracy of the stored analysis information AI may also be improved through a feedback process.

### 3. Description of the Method for Controlling a Product Inspection System 10 According to an Embodiment of the Present Disclosure

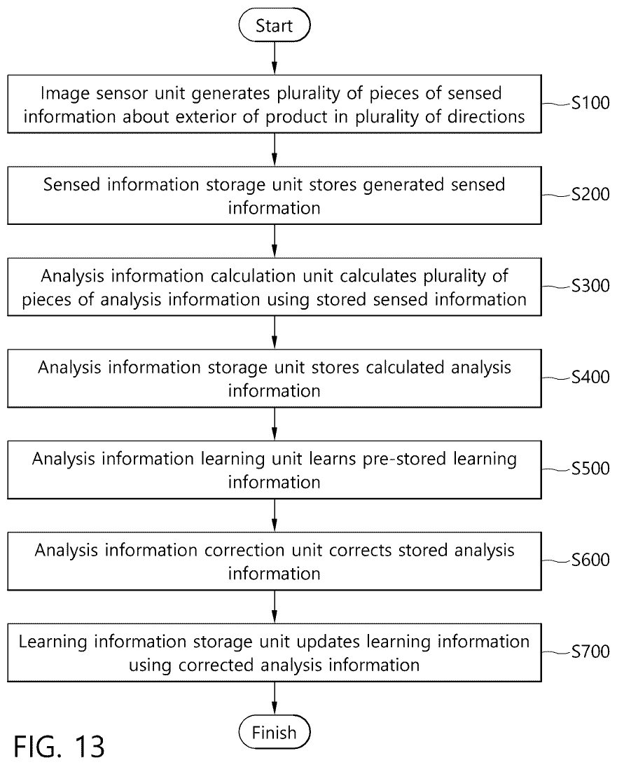

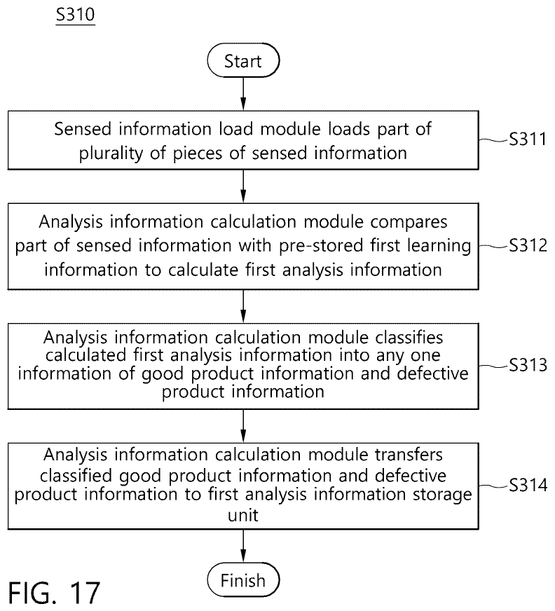

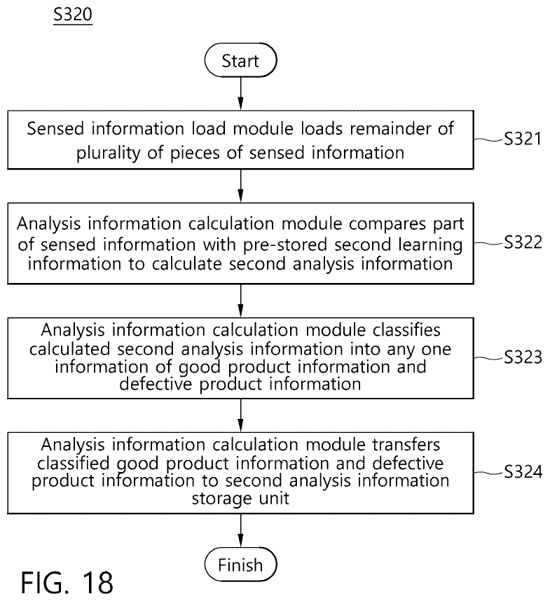

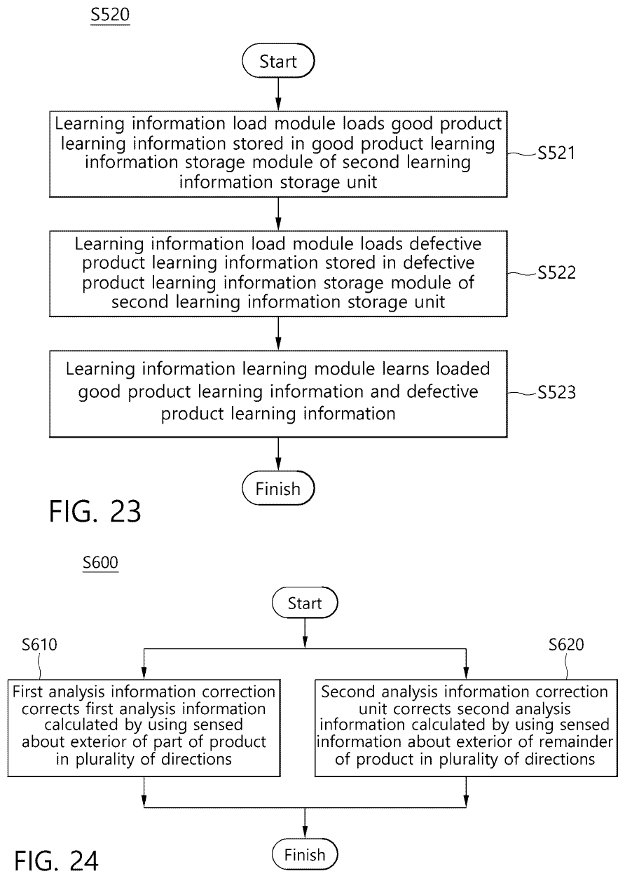

Hereinafter, the method for controlling a product inspection system 10 according to an embodiment of the present disclosure will be described in detail with reference to FIGS. 13 to 27. The method for controlling a product inspection system 10 according to the illustrated embodiment may be implemented by each configuration of the product inspection system 10 described above.

In the embodiment illustrated in FIG. 13, the method for controlling a product inspection system 10 includes a step S100 of generating, by an image sensor unit 100, a plurality of pieces of sensed information SI about an exterior of a product P in a plurality of directions; a step S200 of storing, by a sensed information storage unit 200, the generated sensed information SI; a step S300 of calculating, by an analysis information calculation unit 300, analysis information AI by using the stored sensed information SI; a step S400 of storing, by an analysis information storage unit 400, the calculated analysis information AI, a step S500 of learning, by an analysis information calculation unit 300, pre-stored learning information LI, a step S600 of correcting, by an analysis information correction unit 600, the stored analysis information AI and a step S700 of updating, by a learning information storage unit 500, the learning information LI by using the modified analysis information AI.

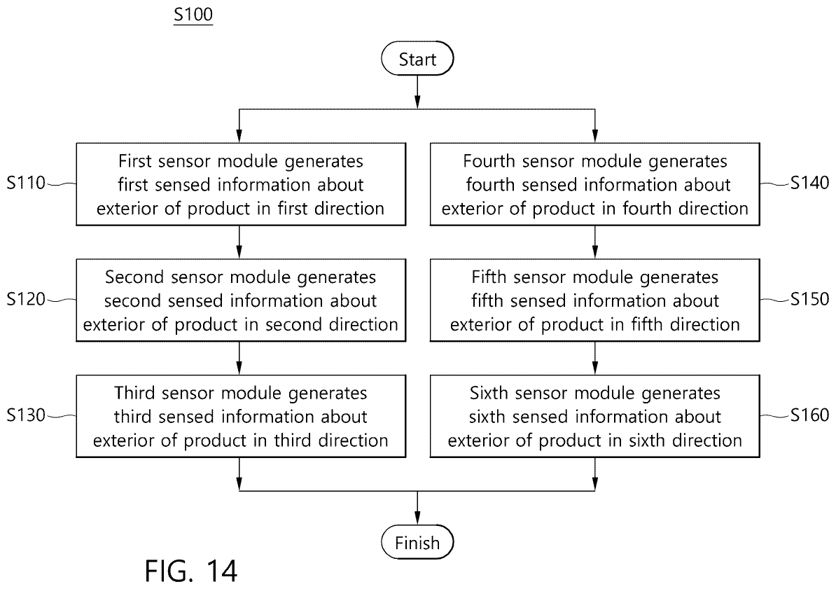

Referring to FIG. 14, the detailed flow of the step S100 in which the image sensor unit 100 generates a plurality of pieces of sensed information SI about the exterior of the product P in a plurality of directions is illustrated. This step S100 is a step S100 in which the image sensor unit 100 generates a plurality of pieces of sensed information SI about an exterior of a product P in a plurality of different directions.

First of all, the first sensor module 110 generates first sensed information SI1 about an exterior of the product P in a first direction S110. The second sensor module 120 generates second sensed information SI3 about an exterior of the product P in a second direction S120, and the third sensor module 130 generates third sensed information SI3 about an exterior of the product P in a third direction S130.

In addition, the fourth sensor module 140 generates fourth sensed information SI4 about an exterior of the product P in a fourth direction S140. The fifth sensor module 150 generates fifth sensed information SI5 about an exterior of the product P in a fifth direction S150, and the sixth sensor module 160 generates sixth sensed information SI6 about an exterior of the product P in a sixth direction S160.

The first to sixth sensed information SI1, SI2, SI3, SI4, SI5, SI6 generated by each sensor module 110, 120, 130, 140, 150, 160 are transferred to the sensed information storage unit 200.

In this case, as described above, in one embodiment, the first to third sensed information SI1, SI2, SI3 may be transferred to the first sensed information storage module 210, and the fourth to sixth sensed information SI4, SI5, SI6 may be transferred to the second sensed information storage module 220.

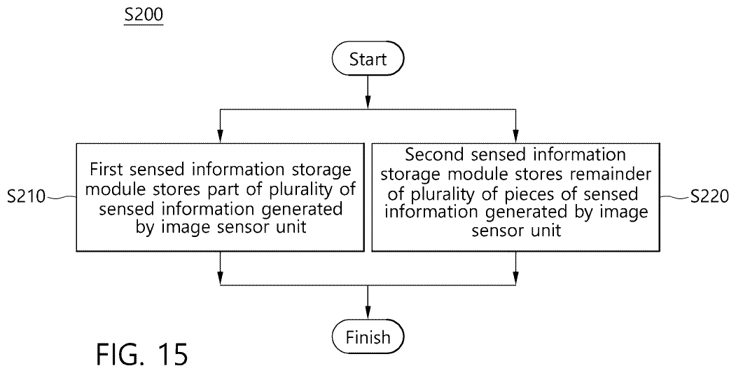

Referring to FIG. 15, the detailed flow of the step S200 in which the sensed information storage unit 200 stores the generated sensed information SI is illustrated. This step S200 is a step S200 in which the sensed information storage unit 200 stores the generated plurality of pieces of sensed information SI1, SI2, SI3, SI4, SI5, SI6 by classifying the same.

First of all, the first sensed information storage module 210 stores a part of the plurality of pieces of sensed information SI1, SI2, SI3, SI4, SI5, SI6 generated by the image sensor unit 100 S210. In one embodiment, the first sensed information storage module 210 may store the first to third sensed information SI1, SI2, SI3.

In addition, the second sensed information storage module 220 stores a remainder of the plurality of pieces of sensed information SI1, SI2, SI3, SI4, SI5, SI6 generated by the image sensor unit 100 S220. In one embodiment, the second sensed information storage module 220 may store the fourth to sixth sensed information SI4, SI5, SI6.

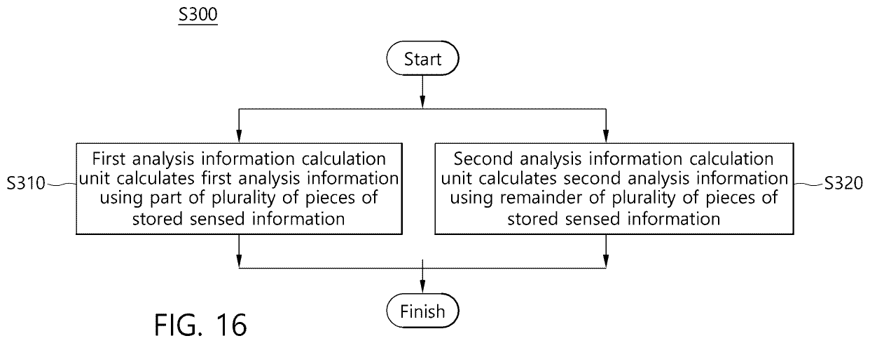

Referring to FIGS. 16 to 18, the detailed flow of the step S300 in which the analysis information calculation unit 300 calculates a plurality of pieces of analysis information AI using the stored sensed information SI is illustrated. This step S300 is a step S300 in which the analysis information calculation unit 300 calculates analysis information AI on the inspection results of the exterior of the product P.

First of all, the first analysis information calculation unit 300a calculates the first analysis information AI1 using a part of the plurality of stored sensed information SI1, SI2, SI3, SI4, SI5, SI6 S310.

Specifically, the sensed information load module 310 provided in the first analysis information calculation unit 300a loads a part of the sensed information SI1, SI2, SI3, SI4, SI5, SI6 stored in the first sensed information storage module 210 S311. In one embodiment, the part may be the first to third sensed information SI1, SI2, SI3.

The analysis information calculation module 320 compares the part of the sensed information SI with pre-stored first learning information LI1 to calculate the first analysis information AI1 S312. In this case, the analysis information calculation module 320 classifies the calculated first analysis information AI1 into any one of good product information or defective product information S313.

The analysis information calculation module 320 transmits the classified good product information and defective product information, that is, the first analysis information AI1, to the first analysis information correction unit 600a S314.

In addition, the second analysis information calculation unit 300b calculates the second analysis information AI2 using the remainder of the plurality of pieces of stored sensed information SI1, SI2, SI3, SI4, SI5, SI6 S320.

Specifically, the sensed information load module 310 provided in the second analysis information calculation unit 300b loads the remainder stored in the second sensed information storage module 220 among the plurality of pieces of sensed information SI1, SI2, SI3, SI4, SI5, SI6 S321. In one embodiment, the remainder may be the fourth to sixth sensed information SI4, SI5, SI6.

The analysis information calculation module 320 compares the remainder of the sensed information SI with pre-stored second learning information LI2 to calculate the second analysis information AI2 S322. In this case, the analysis information calculation module 320 classifies the calculated second analysis information AI2 into any one of good product information or defective product information S323.

The analysis information calculation module 320 transmits the classified good product information and defective product information, that is, the second analysis information AI2, to the second analysis information correction unit 600b S324.

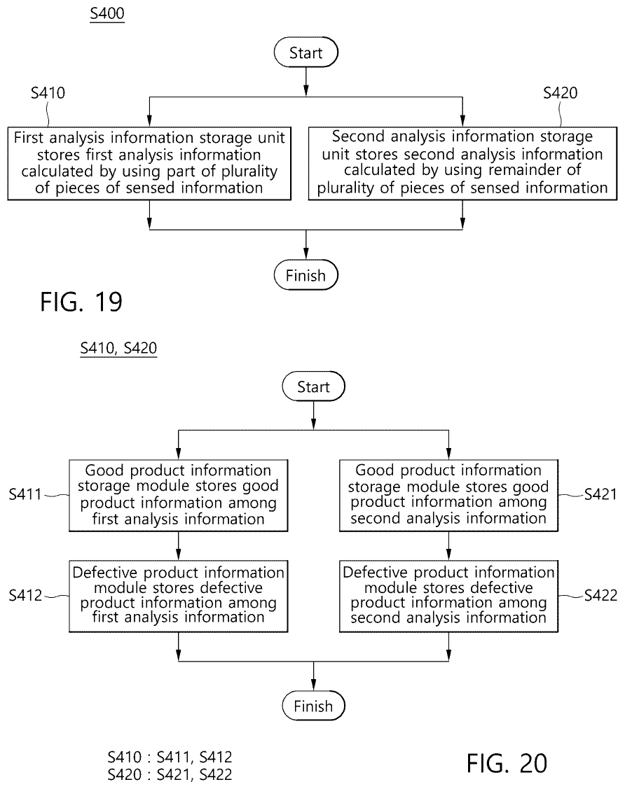

Referring to FIGS. 19 and 20, the detailed flow of a step S400 in which the analysis information storage unit 400 stores the calculated analysis information AI is illustrated. This step S400 is a step S400 in which the calculated first and second analysis information AI1, AI2 are stored separately in the analysis information storage unit 400.

First of all, the first analysis information storage unit 400a stores the first analysis information AI1 calculated by using a part of the plurality of pieces of sensed information SI1, SI2, SI3, SI4, SI5, SI6 S410.

Specifically, the good product information storage module 410 receives and stores good product information among the first analysis information AI1 S411. In addition, the defective product information storage module 420 receives and stores defective product information among the first analysis information AI1 S412.

In addition, the second analysis information storage unit 400b stores the second analysis information AI2 calculated using the remainder of the plurality of pieces of sensed information SI1, SI2, SI3, SI4, SI5, SI6 S420.

Specifically, the good product information storage module 410 receives and stores good product information among the second analysis information AI2 S421. In addition, the defective product information storage module 420 receives and stores defective product information among the second analysis information AI2 S422.

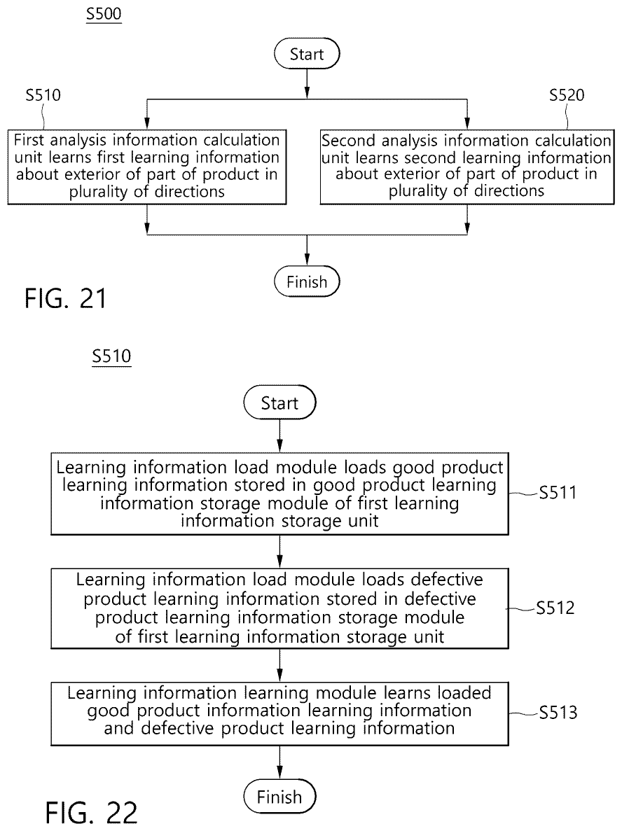

Referring to FIGS. 21 to 23, the detailed flow of a step S500 in which the analysis information calculation unit 300 learns the pre-stored learning information LI is illustrated. This step S500 is a step S500 in which learning is performed to improve the accuracy of the analysis information AI calculated by the analysis information calculation unit 300.

First of all, the first analysis information calculation unit 300a learns first learning information LI1 about the exterior of a part of a product P in a plurality of directions S510. It will be understood that the directions of the part are directions corresponding to the calculated first analysis information AI1.

Specifically, the learning information load module 330 loads the good product learning information stored in the good product learning information storage module 510 of the first learning information storage unit 500a S511, and the learning information load module 330 loads the defective product learning information stored in the defective product learning information storage module 520 of the first learning information storage unit 500a S512. The learning information learning module 340 learns the loaded first learning information LI1, that is, the good product learning information and the defective product learning information S513.

In addition, the second analysis information calculation unit 300b learns second learning information LI2 about the exterior of the remainder of directions among the plurality of directions of the product P S520. It will be understood that the remainder of directions is directions corresponding to the calculated second analysis information AI2.

Specifically, the learning information load module 330 loads the good product learning information stored in the good product learning information storage module 510 of the second learning information storage unit 500b S521, and the learning information load module 330 loads the defective product learning information stored in the defective product learning information storage module 520 of the second learning information storage unit 500b S522. The learning information learning module 340 learns the loaded second learning information LI2, that is, the good product learning information and the defective product learning information S523.

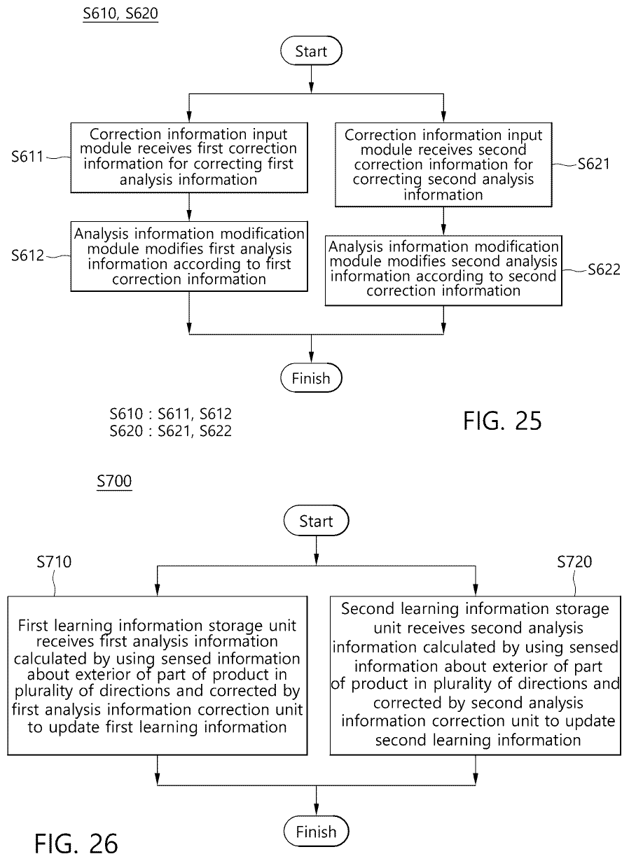

Referring to FIGS. 24 and 25, the detailed flow of the step S600 in which the analysis information correction unit 600 corrects the stored analysis information AI is illustrated. This step S600 is a step S600 in which the analysis information correction unit 600 receives correction information CI and corrects the stored analysis information AI according to the input correction information CI.

First of all, the first analysis information correction unit 600a corrects the first analysis information AI1 calculated by using sensed information SI1, SI2, SI3 on the exterior of a part of the product P in the plurality of directions S610.

Specifically, the correction information input module 610 receives first correction information CI1 for correcting the first analysis information AI1 S611. The analysis information modification module 620 modifies the first analysis information AI1 according to the input first correction information CI1 S612.

In addition, the second analysis information correction unit 600b corrects the second analysis information AI2 calculated by using the sensed information SI4, SI5, SI6 on the exterior of the remainder of a plurality of directions of the product P S620.

Specifically, the correction information input module 610 receives second correction information CI2 for correcting the second analysis information AI2 S621. The analysis information modification module 620 modifies the second analysis information AI2 according to the input second correction information CI2 S622.

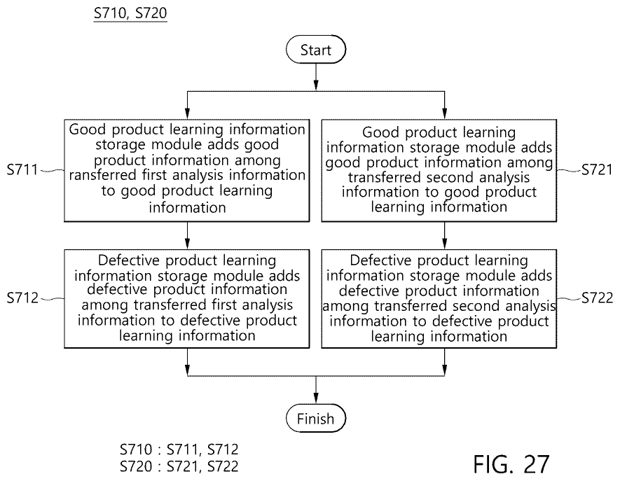

Referring to FIGS. 26 and 27, the detailed flow of the step S700 in which the learning information storage unit 500 updates the learning information LI using the corrected analysis information AI is illustrated. This step S700 is a step S700 in which the learning information LI stored in the learning information storage unit 500 is updated by using the corrected analysis information AI according to the correction information CI.

First of all, the first learning information storage unit 500a calculates the first analysis information AI1 by using sensed information SI1, SI2, SI3 on the exterior of a part of the plurality of directions of the product P and receives the first analysis information AI1 corrected by the first analysis information correction unit 600a to update the first learning information LI1 S710.

Specifically, the good product learning information storage module 510 adds the good product information among the transferred first analysis information AI1, that is, the corrected first analysis information AI1, to the good product learning information S511. In addition, the defective product learning information storage module 520 adds the defective product information among the transferred first analysis information AI1, that is, the corrected first analysis information AI1, to the defective product learning information S512.

In addition, the second learning information storage unit 500b calculates the second analysis information AI2 by using the sensed information SI4, SI5, SI6 on the remainder of exteriors among the plurality of directions of the product P and receives the second analysis information AI2 corrected by the second analysis information correction unit 600b to update the second learning information LI2 S720.

Specifically, the good product learning information storage module 510 adds the good product information among the transferred second analysis information AI2, that is, the corrected second analysis information AI2, to the good product learning information S521. In addition, the defective product learning information storage module 520 adds the defective product information among the transferred second analysis information AI2, that is, the corrected second analysis information AI2, to the defective product learning information S522.

As described above, according to the method for controlling a product inspection system 10 according to an embodiment of the present disclosure, sensed information SI on the exterior of a product P may be generated along various directions. The generated plurality of pieces of sensed information SI are each calculated into a plurality of analysis information AI by a plurality of analysis information calculation units 300a, 300b. Therefore, the calculation speed may be improved compared to a case where the analysis information AI is calculated by a single means.

In addition, the calculated analysis information AI may be accurately corrected by the input correction information CI such that the reliability of the calculation result of the analysis information AI can be improved.

Furthermore, the learning information LI is updated by the corrected analysis information AI, and the analysis information calculation unit 300 performs learning using the updated learning information LI. Accordingly, the reliability of the analysis information AI calculated by the analysis information calculation unit 300 may be improved.

Although the embodiments of the present disclosure have been described, the spirit of the present disclosure is not limited to the embodiments presented in the present specification, and those skilled in the art who understand the idea of the present disclosure will be able to easily suggest other embodiments by modifying, changing, deleting or adding components within the scope of the same spirit, but this will also be considered to fall within the spirit of the present disclosure.

| | |
|---|---|
| 10: Product inspection system | 100: Image sensor unit |
| 110: First sensor module | 120: Second sensor module |
| 130: Third sensor module | 140: Fourth sensor module |
| 150: Fifth sensor module | 160: Sixth sensor module |
| 200: Sensed information storage unit | 210: First sensed information storage module |
| 220: Second sensed information storage module | 300: Analysis information calculation unit |
| 300a: First analysis information calculation unit | 300b: Second analysis information calculation unit |
| 310: Sensed information load module | 320: Analysis information calculation module |
| 330: Learning information load module | 340: Learning information learning module |
| 400: Analysis information storage unit | 400a: First analysis information storage unit |
| 400b: Second analysis information storage unit | 410: Good product information storage module |
| 420: Defective product information storage module | 500: Learning information storage unit |
| 500a: First learning information storage unit | 500b: Second learning information storage unit |
| 510: Good product learning information storage module | 520: Defective product learning information storage module |
| 600: Analysis information correction unit | 600a: First analysis information correction unit |
| 600b: Second analysis information correction unit | 610: Correction information input module |
| 620: Analysis information modification module | P: Product |
| L: Manufacturing line | SI: Sensed information |
| SI1: First sensed information | SI2: Second sensed information |
| SI3: Third sensed information | SI4: Fourth sensed information |
| SI5: Fifth sensed information | SI6: Sixth sensed information |
| AI: Analysis information | AI1: First analysis information |
| AI2: Second analysis information | LI: Learning information |
| LI1: First learning information | LI2: Second learning information |
| CI: Correction information | CI1: First correction information |
| CI2: Second correction information | |

1. A method for controlling a product inspection system, the method comprising:
(a) generating, by an image sensor unit, a plurality of pieces of sensed information about an exterior of a product in a plurality of directions;
(b) storing, by a sensed information storage unit, the generated sensed information;
(c) calculating, by an analysis information calculation unit, analysis information by using the stored sensed information; and
(d) storing, by an analysis information storage unit, the calculated analysis information.

2. The method of claim 1, wherein step (a) comprises:
(a1) generating, by a first sensor module, first sensed information about an exterior of the product in a first direction;
(a2) generating, by a second sensor module, second sensed information about an exterior of the product in a second direction; and
(a3) generating, by a third sensor module, third sensed information about an exterior of the product in a third direction.

3. The method of claim 1, wherein step (a) comprises:
(a4) generating, by a fourth sensor module, fourth sensed information about an exterior of the product in a fourth direction;
(a5) generating, by a fifth sensor module, fifth sensed information about an exterior of the product in a fifth direction; and
(a6) generating, by a sixth sensor module, sixth sensed information about an exterior of the product in a sixth direction.

4. The method of claim 1, wherein step (b) comprises:
(b1) storing, by a first sensed information storage module, a part of the plurality of pieces of sensed information generated by the image sensor unit; and
(b2) storing, by a second sensed information storage module, a remainder of the plurality of pieces of sensed information generated by the image sensor unit.

5. The method of claim 1, wherein step (c) comprises:
(c1) calculating, by a first analysis information calculation unit, first analysis information using a part of the plurality of pieces of stored sensed information; and
(c2) calculating, by a second analysis information calculation unit, second analysis information using a remainder of the plurality of pieces of stored sensed information.

6. The method of claim 5, wherein step (c1) comprises:
(c11) loading, by a sensed information load module, the part of the plurality of pieces of sensed information;
(c12) calculating, by an analysis information calculation module, first analysis information by comparing the part of sensed information with pre-stored first learning information;
(c13) classifying the first analysis information calculated by the analysis information calculation module into any one information of good product information and defective product information; and
(c14) transferring the good product information and the defective product information classified by the analysis information calculation module to a first analysis information storage unit.

7. The method of claim 5, wherein step (c2) comprises:
(c21) loading, by a sensed information load module, the remainder of the plurality of pieces of sensed information;
(c22) calculating, by an analysis information calculation module, second analysis information by comparing the part of the sensed information with pre-stored second learning information;
(c23) classifying the second analysis information calculated by the analysis information calculation module into any one information of good product information and defective product information; and
(c24) transferring the good product information and the defective product information classified by the analysis information calculation module to a second analysis information storage unit.

8. The method of claim 1, wherein step (d) comprises:
(d1) storing, by a first analysis information storage unit, first analysis information calculated by using a part of the plurality of pieces of sensed information; and
(d2) storing, by a second analysis information storage unit, second analysis information calculated by using a remainder of the plurality of pieces of sensed information.

9. The method of claim 8, wherein step (d1) comprises:
(d11) storing, by a good product information storage module, good product information among the first analysis information; and
(d12) storing, by a defective product information storage module, defective product information among the first analysis information.

10. The method of claim 8, wherein step (d2) comprises:
(d21) storing, by a good product information storage module, good product information among the second analysis information; and
(d22) storing, by a defective product information storage module, defective product information among the second analysis information.

11. The method of claim 1, further comprising:
(e) learning, by the analysis information calculation unit, pre-stored learning information.

12. The method of claim 11, wherein step (e) comprises:
(e1) learning, by a first analysis information calculation unit, first learning information about an exterior of a part of the product in a plurality of directions; and
(e2) learning, by a second analysis information calculation unit, second learning information about an exterior of a remainder of the product in a plurality of directions.

13. The method of claim 12, wherein step (e1) comprises:
(e11) loading, by a learning information load module, good product learning information stored in a good product learning information storage module of a first learning information storage unit;
(e12) loading, by a learning information load module, defective product learning information stored in a defective product learning information storage module of the first learning information storage unit; and
(e13) learning the good product learning information and the defective product learning information loaded by a learning information learning module.

14. The method of claim 12, wherein step (e2) comprises:
(e21) loading, by a learning information load module, good product learning information stored in a good product learning information storage module of a second learning information storage unit;
(e22) loading, by a learning information load module, defective product learning information stored in a defective product learning information storage module of the second learning information storage unit; and
(e23) learning the good product learning information and the defective product learning information loaded by a learning information learning module.

15. The method of claim 1, further comprising:
(f) correcting, by an analysis information correction unit, the stored analysis information.

16. The method of claim 15, wherein step (f) comprises:
(f1) correcting, by a first analysis information correction unit, first analysis information calculated by using the sensed information for an exterior of a part of the product in a plurality of directions; and
(f2) correcting, by a second analysis information correction unit, second analysis information calculated by using the sensed information for an exterior of a remainder of the product in a plurality of directions.

17. The method of claim 16, wherein step (f1) comprises:
(f11) receiving, by a correction information input module, an input of first correction information for correcting the first analysis information; and
(f12) modifying, by an analysis information modification module, the first analysis information according to the first correction information, and wherein step (f2) comprises:
(f21) receiving, by a correction information input module, an input of second correction information for correcting the second analysis information; and
(f22) modifying, by an analysis information modification module, the second analysis information according to the second correction information.

18. (canceled)

19. The method of claim 1, further comprising:
(g) updating, by a learning information storage unit, the learning information by using the corrected analysis information.

20. The method of claim 19, wherein step (g) comprises:
(g1) updating, by a first learning information storage unit, first learning information by receiving first analysis information calculated by using the sensed information about an exterior of a part of the product in a plurality of directions, and corrected by a first analysis information correction unit; and
(g2) updating, by a second learning information storage unit, second learning information by receiving second analysis information calculated by using the sensed information about an exterior of a remainder of the product in a plurality of directions, and corrected by a second analysis information correction unit.

21. The method of claim 20, wherein step (g1) comprises:
(g11) adding, by a good product learning information storage module, good product information among the transferred first analysis information to good product learning information;
(g12) adding, by a defective product learning information storage module, defective product learning information among the transferred first analysis information to defective product learning information, and
wherein step (g2) comprises:
(g21) adding, by a good product learning storage module, good product information among the transferred second analysis information to good product learning information; and
(g22) adding, by a defective product learning information storage module, defective product information among the transferred second analysis information to defective product learning information.

22. (canceled)
